(19) United States
(12) Patent Application Publication
(10) Pub. No.: US 2006/0063423 A1
(43) Pub. Date: Mar. 23, 2006

(54) Consolidated meter socket support base

(76) Inventors: Paul David Seff, Lincoln, IL (US); Syed M. Karim, Lincoln, IL (US)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 10/945,496

(22) Filed: Sep. 20, 2004

(51) Int. Cl. H01R 33/945

(52) U.S. Cl. 439/517

(57) ABSTRACT

A meter socket assembly that includes a unitary socket base and a conductor assembly. The unitary socket base having a platform portion and at least two risers extending upwardly from the base portion, each riser having a distal end. The conductor assembly has at least one jaw assembly with a conductor extending from the platform portion to at least one distal end.

### BACKGROUND OF THE INVENTION

1. Field of the Invention

The present invention relates to a meter socket and, more specifically, to a unitary meter socket support base.

2. Background Information

Meter centers are used for metering electric power delivered to multiple tenants from a common feeder system. Typically, the meter center includes an upright cabinet forming an enclosure divided into side-by-side meter and disconnect switch compartments. Feeder buses, typically three-phase buses and a neutral bus connected to the utility lines, extend horizontally through the rear of the cabinet. The meter compartment has a pair of vertical supply buses, or “line” buses, connected to a selected pair of the feeder phase buses by phase balancers, so named because connections can be made to selected phases to generally balance the feeder bus phase currents. The line buses can include a neutral bus if the meters have a neutral connection. A meter socket is structured to mount a meter in the meter compartment for each tenant load circuit and electrically connects the meter to the supply buses and the tenant load buses.

That is, the meter socket includes a plurality of pincer-like jaw assemblies. Each jaw assembly is in electrical communication with either the line or the load buses within the meter center. The jaw assemblies face, that is, open toward, the front of the meter center. The meter is, typically, a cylindrical enclosure having a display on the front side, a metering device enclosed therein, and a plurality of conductive stabs extending from the back side. The stabs are structured to be coupled to the jaw assemblies thereby coupling the line and load buses through the meter. In this configuration, the metering device may collect data as to how much electricity is used by each tenant.

The meter socket was, typically, an assembly that included multiple components. For example, typically, a pair of meterjaws are supported by base unit. Two or more base units are required to support a meter. Additionally, the conductors were typically coupled by one or more fasteners to the separate base units. Further, certain base units included separate components, such as pedestals and risers. The pedestals were used to space the base from the meter center housings. The risers were rigid non-conductive members structured to hold lugs in a specific location, spaced away from the base, so that the lugs align with the stabs on a meter. Additionally, the lugs were also coupled to the meter socket assembly by fasteners or other such coupling devices. Because the meter socket assembly included the various separate components, the meter socket assembly needed to be assembled prior to use. To reduce the time and energy required to assemble a meter socket assembly, it would be advantageous to have a meter socket base with a reduced number of components or, more preferably, a single piece base.

There is, therefore, a need for a one-piece molded socket base.

There is a further need for a one-piece molded socket base that incorporates a conductor assembly.

There is a further need for a one-piece molded socket base that reduces the number of fasteners required to mount the socket assembly.

### SUMMARY OF THE INVENTION

These needs, and others, are met by the present invention which provides a meter socket assembly having a one-piece, or “unitary,” molded socket base and a conductor assembly. The unitary socket base is structured to support at least two pairs of meter jaw assemblies. The socket base, which is a unitary body, includes a platform portion and at least two risers extending upwardly from the platform portion. The platform portion has, preferably, a generally square cross-sectional shape. In one embodiment, there are four pedestal risers, one extending from each corner of the platform portion. In a preferred embodiment, the socket base includes two elongated risers extending from two opposite sides of the platform portion. Each elongated riser runs about the entire length of the side of the platform portion from which the riser extends upwardly. The socket base is further structured to be coupled to the conductor assembly with a reduced number of fasteners.

The conductor assembly includes at least one jaw assembly having a pair of pincer-like jaw members and an associated bus, as well as, at least one line bus and at least one load bus. The jaw assembly bus is made from a generally flat, elongated conductive member that has been bent into an L-shape. That is, the jaw assembly bus has a first leg and a second leg which are generally perpendicular to each other. The jaw members are coupled to, and in electrical communication with, the jaw assembly bus first leg, and more specifically to the outer side of the jaw assembly bus first leg. Each riser is structured to support at least one jaw assembly and an associated bus. Each riser includes one or more generally flat plateaus at the distal end of the riser. Each plateau is structured to support a jaw assembly. Each plateau further includes an opening. Each jaw assembly includes a threaded post extending from the jaw assembly bus first leg inner side. The threaded post extends through the plateau opening and may be secured with a nut. The jaw assembly bus second legs extend downwardly adjacent to the risers and are structured to be coupled to either a line or load bus disposed on or within the socket base platform portion. This configuration requires fewer fasteners than the coupling means of the prior art.

### BRIEF DESCRIPTION OF THE DRAWINGS

A full understanding of the invention can be gained from the following description of the preferred embodiments when read in conjunction with the accompanying drawings in which:

FIG. 1 is an isometric view of a unitary socket base with a conductor assembly coupled thereto.

FIG. 2 is an isometric view of a unitary socket base.

FIG. 3 is a front view of a unitary socket base with a conductor assembly coupled thereto.

### DESCRIPTION OF THE PREFERRED EMBODIMENTS

As used herein, “unitary” shall mean an integral body that does not include separate components coupled together by a fastening means.

As used herein, “inner side,” when describing a side of a jaw assembly bus, shall mean the side adjacent to the socket base. Similarly, “outer side,” when describing a side of a jaw assembly bus, shall mean the side facing away from the socket base.

As used herein, directional terms, such as “upper” and “lower” relate to the socket assembly as shown in the Figures and are not limiting upon the claims.

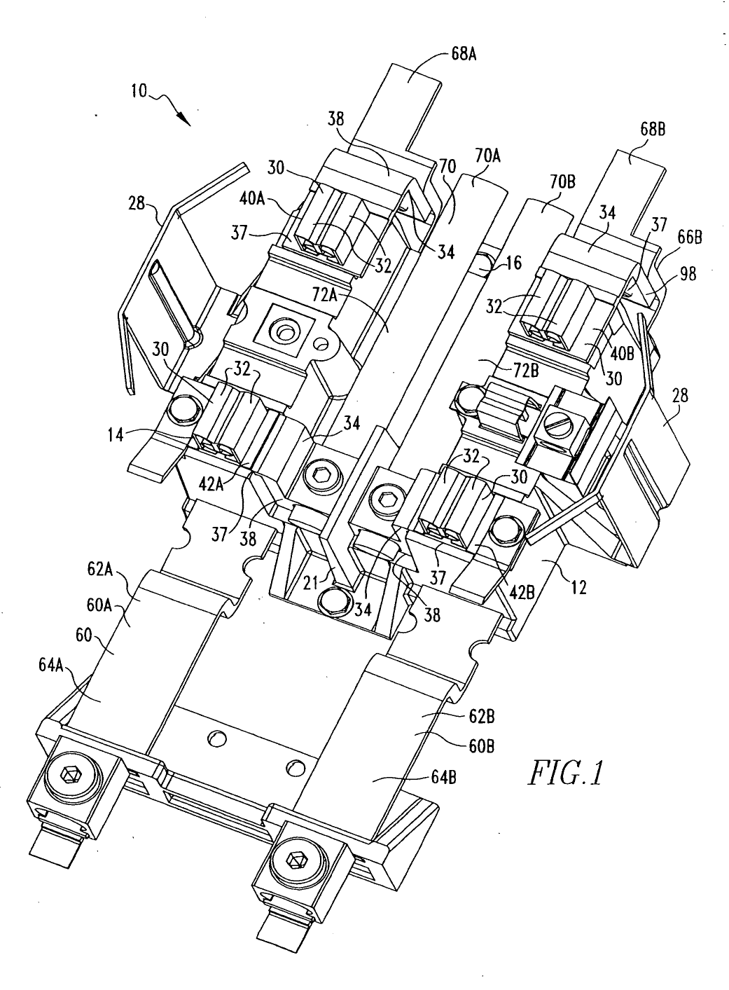

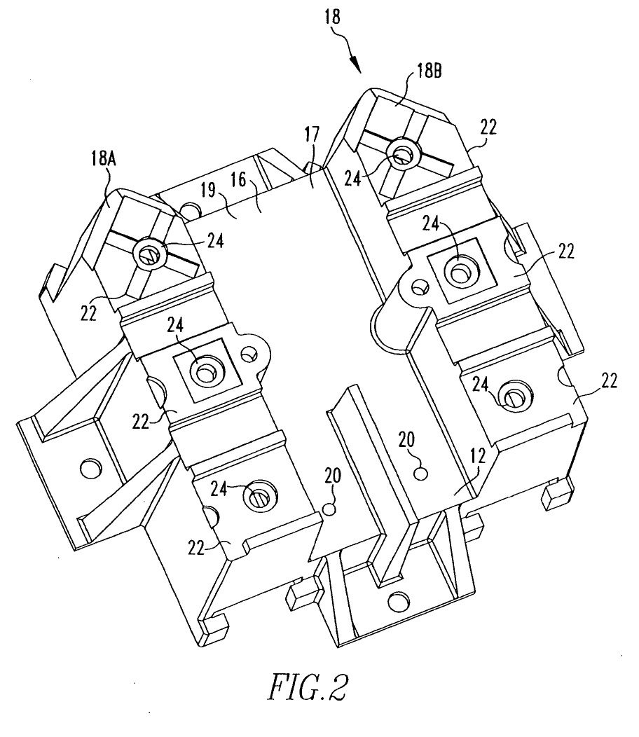

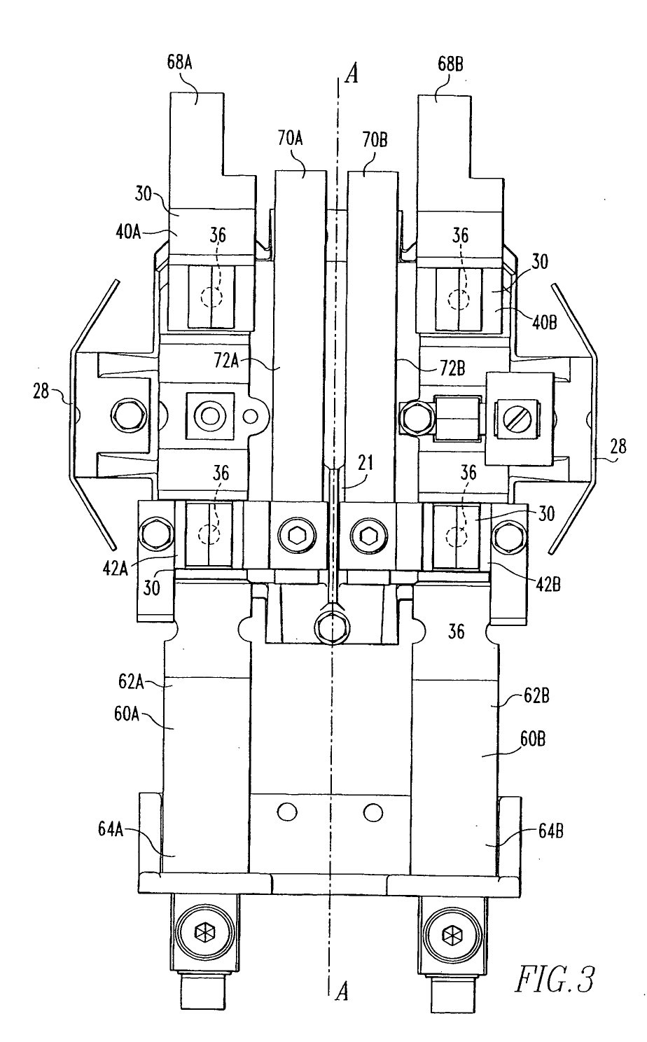

As shown in FIG. 1, a meter socket assembly 10 includes a non-conductive, unitary socket base 12 and a conductor assembly 14. As shown in FIG. 2, the socket base 12, which is a unitary body 13, includes a platform portion 16 and at least two risers 18 extending upwardly from the platform portion 16. In a preferred embodiment, the platform portion 16 is a generally planar member having a square cross-sectional shape and an upper surface 17. In one embodiment, discussed below, there are four pedestal-like risers 118 (FIG. 4), one extending from each corner of the platform portion upper surface 17. However, in the preferred embodiment, the socket base 12 includes two elongated risers 18A, 18B extending from the platform portion upper surface 17 along two opposite edges of the platform portion 16. Between the two elongated risers 18A, 18B is a generally flat conductor seat 19 structured to support the load conductors 70A, 70B, described below. The seat further includes two lug fastener openings 20 structured to accommodate the load conductor lugs 44A, 44B described below. Between the lug fastener openings 20 is a planar barrier 21 extending generally perpendicular to the plane of the upper surface 17. As will be described below, the planar barrier 21 separates the load conductor lugs 44A, 44B to prevent a short. The planar barrier 21 is molded as part of the unitary body 13. Each elongated riser 18A, 18B runs about the entire length of one of the sides of the generally square platform portion 16. Each elongated riser 18A, 18B has a distal end 23. Each elongated riser 18A, 18B is generally hollow and is open on the bottom side (not shown). At each elongated riser distal end 23 is at least one plateau 22, that is, a flat area. In the preferred embodiment there are three plateaus 22 on each elongated riser 18A, 18B. Each plateau 22 includes an opening 24 extending through the plateau 22. Each opening 24 may be accessed through the open bottom side.

The platform portion 16 preferably has a thickness of between about 1½ and 1⅝ inches and each riser 18 has a height above the platform portion 16 of between about 1⅞ and 2⅛ inches. More preferably, the platform portion 16 preferably has a thickness of about 1⅝ inches and each riser 18 has a height above the platform portion of about 2 inches.

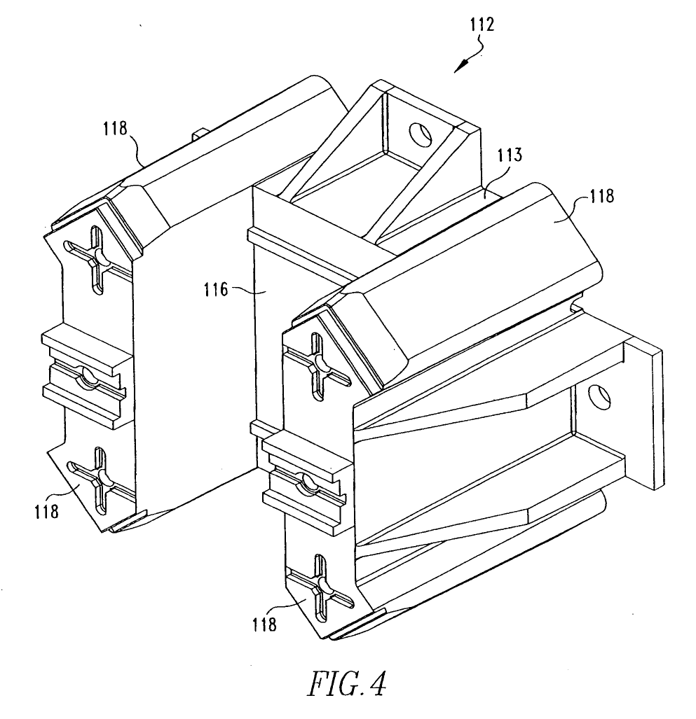

Additionally, as shown in FIGS. 1 and 3, the meter socket assembly 10 may include guide structures 28. The guide structures 28 are not part of the unitary body 13 and are not required for the meter socket assembly 10 to function. The guide structures 28 are disposed on either side of the unitary body 13 and assist a user in aligning the stabs on the back side of a meter assembly (not shown) with the jaw assemblies 30, described below.

As shown in FIGS. 1 and 3, the conductor assembly 14 includes at least one jaw assembly 30, at least one line conductor 60 and at least one load conductor 70. Each jaw assembly 30 includes a pair of separable, pincer-like jaw members 32 that are biased toward each other, a bus 34 and a coupling device 36 (FIG. 3). The jaw members 32 and the jaw assembly bus 34 are made from a conductive material. Each jaw assembly bus 34 is made from a generally flat, elongated conductive member that has been bent into an L-shape. That is, the jaw assembly bus 34 has a first leg 37 and a second leg 38 which are generally perpendicular to each other. The jaw members 32 are coupled to, and in electrical communication with, the jaw assembly bus first leg 37, and, more specifically, to the outer side of the jaw assembly bus first leg 37 as described below. As described below, the jaw assembly bus second leg 38 is sized to extend the length of the risers 18A, 18B. The coupling device 36 is, preferably, a threaded rod that is sized to pass through the plateau openings 24. The coupling device 36 preferably extends from the inner side of the jaw assembly bus first leg 37 opposite the jaw members 32.

In a preferred embodiment the conductor assembly 14 includes at least one and preferably two line side jaw assemblies 40A, 40B and two load side jaw assemblies 42A, 42B, as well as two line conductors 60A, 60B, and two load conductors 70A, 70B. As shown best in FIG. 3, the meter socket assembly 10 is generally symmetrical about the vertical (as shown in FIG. 3) line A-A. Accordingly, the following description addresses one set of components of the conductor assembly 14 that are located on one side of the meter socket assembly 10. These components will be identified by a reference number followed by the letter “A.” It is understood that there is a second set of mirror image components located on the opposite side of the line A-A that will not be described separately. The components on the opposite side will be identified by a reference number followed by the letter “B.”

The line conductor 60A is an elongated, generally flat, conductive member 62A having a first end 64A and a second end 66A. The conductive member 62A extends below the platform portion 16, generally longitudinally under the elongated riser 18A. The line conductor first end 64A extends to one side of the platform portion 16 and is structured to be coupled to the meter center line bus (not shown). The line conductor second end 66A extends from the side of the platform portion 16 opposite the line conductor first end 64A. The line conductor second end 66A may be bent about ninety degrees so that the line conductor second end 66A extends generally parallel to the side of the elongated riser 18A. The line conductor second end 66A may further include a lug tab 68A extending generally parallel to the plane of the platform portion 16. If desired, a coupling lug may be placed on the lug tab 68A. The load conductor 70A is, preferably, an insulated wire 72A. The insulated wire 72A is disposed between the two elongated risers 18A, 18B and on top of the conductor seat 19.

The meter socket assembly 10 is assembled as follows. The line side jaw assembly 40A is disposed on the upper (as shown in FIG. 3) plateau 22 of the elongated riser 18A. The line side jaw assembly 40A second leg 38 extends downwardly along the top side of the elongated riser 18A. The line side jaw assembly 40A coupling device 36 is disposed through the plateau opening 24 and a nut is threaded on thereto, thereby coupling the line side jaw assembly 40A to the elongated riser 18A. Similarly, the load side jaw assembly 42A is disposed on the lower (as shown in FIG. 3) plateau 22 of the elongated riser 18A. The load side jaw assembly 42A second leg 38 extends downwardly along the inner side of the elongated riser 18A to a point adjacent to the conductor seat 19. Where the load conductor 70A is an insulated wire 72A, the load side jaw assembly 42A preferably includes a load conductor lug 44A disposed at the distal end of, and in electrical communication with, the load side jaw assembly 42A second leg 38. The load conductor lug 44A may have a coupling device (not shown), such as a threaded rod, extending through the lug fastener opening 20 which is secured with a nut (not shown). The load side jaw assembly 42A coupling device 36 is disposed through the plateau opening 24 and a nut is threaded on thereto, thereby coupling the load side jaw assembly 42A to the elongated riser 18A.

After the line side jaw assembly 40A and the load side jaw assembly 42A are secured, the line conductor 60A is disposed on the lower side of the platform portion 16 generally longitudinally under the elongated riser 18A. The line side jaw assembly 40A second leg 38 extends downwardly along the side of the elongated riser 18A and is parallel to the line conductor second end 66A. Thus, the line side jaw assembly 40A second leg 38 and the line conductor second end 66A are joined together by a coupling device 36. The load conductor 70A is disposed between the two elongated risers 18A, 18B and on top of the conductor seat 19. The load conductor 70A is further coupled to the load conductor lug 44A. Thus, in this configuration, the line conductor 60A is coupled to, and in electrical communication with, the line side jaw assembly 40A, and, the load conductor 70A is coupled to, and in electrical communication with, the load side jaw assembly 42A. Thus, when a meter is coupled to the meter socket assembly 10 a circuit is completed and the flow of electricity through the meter may be monitored and recorded.

While specific embodiments of the invention have been described in detail, it will be appreciated by those skilled in the art that various modifications and alternatives to those details could be developed in light of the overall teachings of the disclosure. For example, it is further noted that elongated risers 18A, 18B may further include a medial plateau 22. Additional jaw assemblies 40, such as jaw assembly 40 coupled to a neutral conductor, may be disposed at the medial plateaus. Accordingly, the particular arrangements disclosed are meant to be illustrative only and not limiting as to the scope of invention which is to be given the full breadth of the claims appended and any and all equivalents thereof.

What is claimed is:

1. A meter socket assembly comprising:
a non-conductive, unitary socket base having a platform portion and at least two risers extending upwardly from said base portion, each said riser having a distal end; and
a conductor assembly having at least one jaw assembly with a conductor extending from said platform portion to at least one distal end.

2. The meter socket assembly of claim 1, wherein said platform portion has a generally square cross-sectional shape and said at least two risers includes two elongated risers extending from opposite edges of said platform portion.

3. The meter socket assembly of claim 2, wherein each said at least two risers includes a plurality of plateaus at said distal end, said plateaus structured to support a jaw assembly.

4. The meter socket assembly of claim 3, wherein each said plateau includes an opening.

5. The meter socket assembly of claim 4, wherein said conductor assembly further includes at least one line conductor and at least one load conductor.

6. The meter socket assembly of claim 5, wherein said conductor assembly includes two line conductors, two load conductors and four jaw assemblies.

7. The meter socket assembly of claim 6, wherein:
said four jaw assemblies includes two line side jaw assemblies and two load side jaw assemblies;
one said line side jaw assembly and one said load side jaw assembly disposed on each said elongated riser; and
each said line side jaw assembly coupled to a line conductor and each said load side jaw assembly coupled to a load conductor.

8. The meter socket assembly of claim 6, wherein each said jaw assembly is disposed on a riser plateau.

9. The meter socket assembly of claim 8, wherein:
said platform portion has a thickness of between about 1½ and 1⅝ inches; and
each said riser has a height above said base of between about 1⅞ and 2⅛ inches.

10. The meter socket assembly of claim 9, wherein:
said platform portion has a thickness of about 1⅝ inches; and
each said riser has a height above said base of about 2 inches.

11. A socket base for a meter socket assembly, said socket base comprising:
a non-conductive, unitary body having a platform portion and at least two risers extending upwardly from said base portion, each said riser having a distal end; and
a conductor assembly having at least one jaw assembly with a conductor extending from said platform portion to at least one distal end.

12. The socket base of claim 11, wherein said platform portion has a generally square cross-sectional shape and said at least two risers includes two elongated risers extending from opposite edges of said platform portion.

13. The socket base of claim 12, wherein each said at least two risers includes a plurality of plateaus at said distal end, said plateaus structured to support a jaw assembly.

14. The socket base of claim 13, wherein each said plateau includes an opening.

15. The socket base of claim 11, wherein:
said platform portion has a thickness between about 1½ and 1⅝ inches; and
each said riser has a height above said base of between about 1⅞ and 2⅛ inches.

16. The socket of claim 15, wherein:
said platform portion has a thickness of about 1⅝ inches; and
each said riser has a height above said base of about 2 inches.
